(19) United States
(12) Patent Application Publication
(10) Pub. No.: US 2015/0342227 A1
(43) Pub. Date: Dec. 3, 2015

(54) COMBINATION OF DRYING AND SMOKING

(71) Applicant: GEA FOOD SOLUTIONS BAKEL B.V., Bakel (NL)

(72) Inventors: Paul Verbruggen, MD Helmond (NL); Ben Kop, LR Esch (NL)

(73) Assignee: GEA FOOD SOLUTIONS BAKEL B.V., Bakel (NL)

(21) Appl. No.: 14/759,003

(22) PCT Filed: Jan. 6, 2014
(86) PCT No.: PCT/EP2014/050077

§ 371 Date: Jul. 2, 2015

(30) Foreign Application Priority Data
Jan. 4, 2013 (EP) 13150319.5

(51) Int. Cl. A23L 1/01; A23L 1/232; A21B 1/48; A47J 27/62; A47J 37/04; A23B 4/052

(52) U.S. Cl. CPC A23L 1/01; A47J 37/04; A23B 4/0526; A21B 1/48; A47J 27/62; A23L 1/232; A23V 2002/00

(57) ABSTRACT

The present invention relates to a line comprising an oven and a drying chamber. The present invention further relates to a process how to cook s food product.

The present invention relates to a line comprising an oven and a drying chamber. The present invention further relates to a process to cook food products.

Ovens according to the state of the art are for example known from EP 1 221 575 A1 and EP 0 558 151A1 and are suitable for the complete or partial cooking of edible food products, especially protein containing products, like chicken, hamburgers, cordon bleu etc. The above mentioned patent applications are herewith included by reference and are therefore part of the disclosure of the present patent application. The temperature and humidity can be set such, that during the residence time in the oven, which is dependent on the length and velocity of the conveyor belt, the desired cooking and, if needed, browning is effected. Nowadays, the market has an increasing demand for smoked and/or flavored and dried products. This smoking and/or flavoring is, according to the state of the art, carried out after or before the product is cooked, off line in a separate smoking- and/or flavoring house, which is time consuming and requires a lot of space.

It is therefore an objective of the present invention to provide a line suitable for drying, cooking and smoking of food products.

The problem is solved with a line comprising:

an oven with
at least one chamber,
conveyor means with for guiding products from the inlet through this chamber to the outlet,
cooking means in the chamber to cook the product and
means to atomize a smoking- and/or a flavoring-liquid in the oven
   and
   a drying chamber upstream from the cooking means.

The oven according to the inventive line comprises at least one chamber, preferably two or more chambers. In each chamber a zone with different heat-transfer-, temperature-, humidity- and/or smoking/flavoring-conditions can preferably be established. The food product to be treated is preferably protein-containing food like meat or fish. Alternatively, the food product can be a vegetarian product, for example a meat- and/or fish-replacement-product. The food product may comprise bones or fish-bones. The inventive oven further comprises conveyor means for guiding products from the inlet through this chamber to the outlet. The conveyor means is preferably at least partially arranged in a helical path, whereas in one chamber, the products are preferably conveyed helically upwards and in another chamber, the products are preferably conveyed helically downwards. Two helical conveyors are preferably connected by a straight conveyor section. The conveyor means are preferably an endless conveyor belt, which more preferably is at least partially permeable for the process gas, i.e. air, steam and/or the smoke/flavoring-substance. Additionally, the oven comprises temperature control means for adjusting and controlling the temperature and/or humidity in at least one chamber using a gas, which is normally a mixture of air and steam. The temperature of the gas is adjusted by a heater. The humidity of the gas is adjusted by adding steam or for example air with a low humidity. Preferably, the gas is circulated in the each chamber, preferably separately, preferably by a blower, which extracts the gas out of the chamber at one end and reintroduces the gas at another end. Due to this recirculation, there is a gas-motion in the chamber that improves the heat-transfer from the gas to the product and/or reduces temperature differences in each chamber and/or improves the mass transfer during drying. Preferably, the conditions in each chamber can be controlled individually.

At least in one chamber of the oven, the food products are cooked, i.e. the core temperature of the product is raised above at least 50° C., preferably above 60° C., more preferably above 70° C., even more preferably above 80° C. and even more preferably above 90° C.

According to the invention, the oven and/or preferably the drying chamber comprise means to atomize a smoking- and/or a flavoring-liquid. The smoking- and/or flavoring-liquid is preferably a water-like-substance. The means to atomize the smoking- and/or flavoring-liquid in the oven is preferably a nozzle, more preferably a two phase nozzle, which is operated with the smoking- and/or flavoring-liquid and a gas, preferably air. The two phase nozzle is preferably supplied with compressed air between 1 and 15 bar, more preferably 3 and 8 bar, even more preferably 4-6 bar. The ratio of the smoking- and/or flavoring-liquid-flow to the nozzle versus the gas-flow to nozzle is preferably 0.1-1.0 kg/m³, more preferably 0.3-0.6 kg/m³. The gas-flow to each nozzle is preferably set to 3.0 to 10.0 m³/h, more preferably 5.0 to 6.5 m³/h and the smoking- and/or a flavoring-liquid is preferably adjusted at a flow rate of 0.2 to 25 kg/h more preferably 1 to 10 kg/h, even more preferably 3-6 kg/h. The means to atomize the smoking- and/or flavoring-liquid can comprise one or more nozzles, for example an array of nozzles. The atomizing means may provide the atomized smoking- and/or a flavoring-liquid continuously or intermittently. The droplet-size of the atomized smoking- and/or a flavoring-liquid is preferably <3.0 μm, more preferably <1.5 μm and even more preferably <1.0 μm. During the atomization, preferably part of the atomized smoking- and/or flavoring-liquid is ejected from each nozzle as a gas. This part is preferably less than 20 weight %, more preferably 14-16 weight % of the smoking- and/or a flavoring-liquid supplied to the nozzle. The atomized smoking- and/or a flavoring-liquid-stream is preferably ejected into an air-flow which is circulated in one chamber of the oven, whereas the air-flow preferably has a temperature between 50-250° C., more preferably 100-200 ° C., particularly at the point of ejection of the smoking- and/or flavoring-liquid. The velocity of the air-flow at the point of ejection is preferably between 0.5 and 35 m/s more preferably between 1 and 9 m/s. At least one of the above described conditions assures a complete evaporation of the droplets. Preferably, no means to capture overdosed smoking- and/or a flavoring-liquid need to be provided in the oven.

More preferably, the oven comprises two or more chambers, in which a different temperature, different humidity and/or different heat-transfer-conditions can be set, respectively. Preferably each chamber comprises a blower and/or heating means, whereas the blower and/or the heating means can be operated in each chamber separately. Preferably one or more chambers comprise a helical path and the chambers are more preferably separated from each other, particularly by a third chamber, which is more preferably a section with a straight conveyor belt. Preferably one or more chamber(s) comprises at least one means to provide, preferably atomize a smoking- and/or a flavoring-liquid, whereas the smoking- and/or flavoring-liquid and/or the operation condition of the means, for example a nozzle, can be different in each chamber, respectively. One chamber can be a drying chamber and one chamber can be a cooking chamber. Preferably to both chambers a smoking and/or flavoring substance is provided.

According to the present invention, the product is dried, before it is smoked and/or flavored and cooked. Drying according to the present invention means that the weight of the food product is reduced. The drying the food product can take place due to dripping of a substance from the product and/or due to evaporation of a substance from the surface of the product. Preferably, the weight loss of the product during the drying step is 0.5-30 weight-% relative to the initial weight of the product before it enters the drying chamber, more preferably 2-20 weight-%, even more preferably 3-10 weight-% and even more preferably 4.5-7.5 weight-%. The drying of the products is preferably done in a climatized chamber with exact temperature and humidity parameters. Preferably, the drying of the food product is carried out at a temperature in the range of 60-180° C. in the drying chamber. Also preferably, the drying takes place without heating the drying medium. In this case the drying temperature is preferably between 18 and 30° C. During the drying liquid smoke can be atomized in the drying chamber. The drying chamber is preferably separated from the coking chamber, so that the conditions in drying chamber are not influenced by the conditions in the cooking chamber and vice versa. The cooking and the drying are preferably two independent process steps. The product is dried before it is cooked.

Preferably, the drying chamber is a separate apparatus upstream from the oven, which is however provided inline with an oven in which the smoking/flavoring and/or the cooking takes place. The products leaving the drying chamber are directly transported to the oven in which the product is smoked/Flavored and/or cooked. During the drying the product can also be smoked and/or flavored.

In another preferred embodiment of the present invention, the drying chamber is located in the oven, however upstream from the smoking and/or flavoring chamber and the cooking chamber and totally separate from the cooking chamber. Preferably, the drying chamber is in a first chamber of the oven preferably with a helically shaped conveyor means. More preferably, the cooking means is in a second chamber of the oven preferably with a helically shaped conveyor means. Even more preferably, the first and the second helical conveyor means are connected by straight conveyor means, wherein the means to provide a smoking- and/or a flavoring-substance into the oven are arranged in a chamber along the straight conveyor means and/or in the first chamber preferably with the helically shaped conveyor means. However, liquid smoke and/or liquid flavor can also be atomized in the drying and/or the cooking chamber. The drying and the cooking chamber can be operated totally separately.

Another subject matter of the present invention is a process to dry and cook a food product, wherein the drying takes place upstream from the cooking.

The disclosure made regarding the inventive line also applies to the inventive process and vice versa. Subject matters from the apparatus can be incorporated into the process claims and vice versa.

Preferably, the food product is additionally smoked and/or flavored. More preferably, it is smoked and/or flavored prior to the cooking.

Preferably, the smoking- and/or a flavoring-takes place at least partially simultaneously to the drying step and/or the food product is smoked and/or flavored during its cooking.

In another preferred embodiment, the smoking- and/or a flavoring-takes place after the drying step and/or at least partially simultaneously to the drying step.

Another preferred or inventive embodiment of the present invention is a process in which the food product is dried to a certain extent before a smoking and/or flavoring substance is absorbed.

The disclosure made regarding the inventive line or the above mentioned inventive process also applies to this inventive process and vice versa.

Preferably, the weight loss of the product before the smoke and/or the flavor is absorbed is 0.5-30 weight-% relative to the initial weight of the product before it enters the drying chamber, more preferably 2-20 weight-%, even more preferably 3-10 weight-% and even more preferably 4.5-7.5 weight-%.

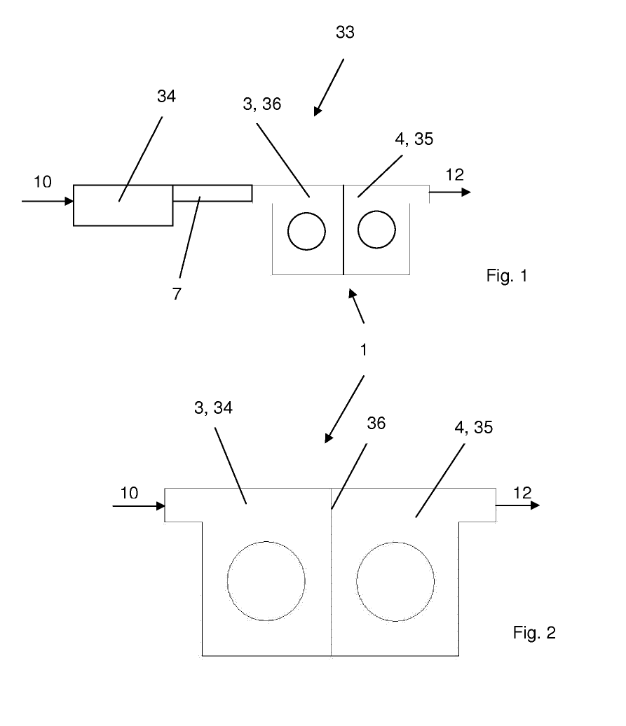

The inventions are now explained according to FIGS. 1-4. These explanations do not limit the scope of protection. The explanations apply for all inventions of the present application likewise.

FIG. 1 shows a first embodiment of the inventive line.

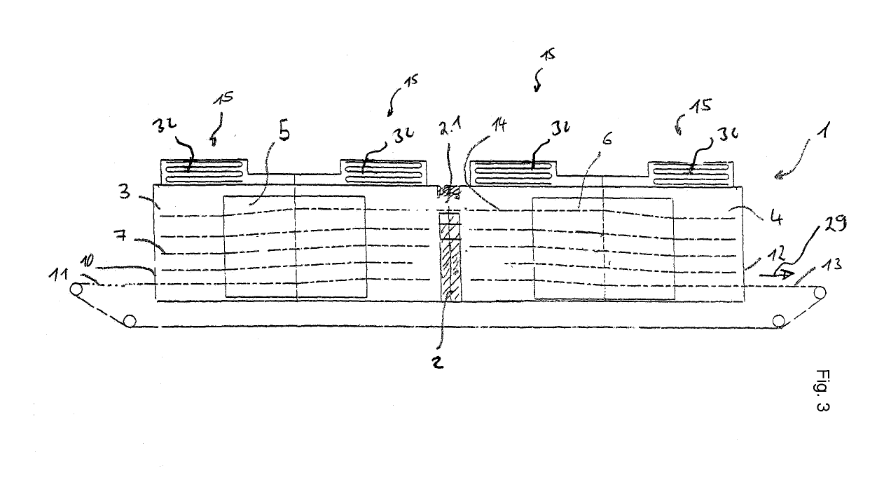

FIG. 2 shows a second embodiment of the inventive line.

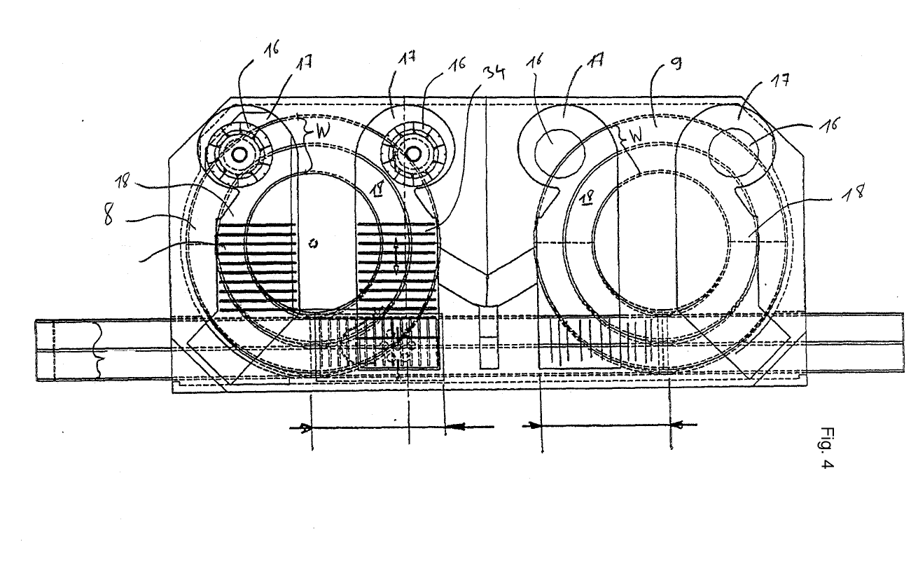

FIG. 3 shows one embodiment of the oven.

FIG. 4 is a top view of the oven according to FIG. 1.

FIG. 1 shows a first embodiment of the inventive line 33. This line comprises an oven 1 with two chambers 3, 4, wherein, in the present example, the first chamber 3 is the smoking/flavoring-chamber and the second chamber 4 is the cooking chamber. In both chambers 3, 4, the conveyor means are, in the present case, arranged in a helical path. Upstream from oven 1, a drying chamber 34 is arranged inline, in which the food products are dried before they are cooked. The drying chamber 34 and the oven 1 are arranged inline which means that the products which leave the drying chamber are directly fed into the oven 1. The smoking and/or flavoring of the product can take place in the drying chamber and/or in the oven, by atomizing a smoking and/or flavoring liquid in the chamber 34 and/or in the oven.

FIG. 2 shows another embodiment of the inventive line. In the present case, the all three chambers 34, 35, 36 are arranged in one unit, here the oven 1. In the two chambers 34 and 35, the conveyor belt, which transports the products through the oven, are arranged in a helical path. These helical paths are connected by a section, in which the conveyor belt is straight. In this section, the chamber 36 is provided. Preferably, in each chamber, the relative humidity and/or the temperature can be set individually. According to the present invention, the drying chamber 34 is located upstream from the cooking chamber 35. In between, the smoking/flavoring chamber 36 is provided. However, additionally or alternatively, the smoking/flavoring can also take place in the cooking chamber 36 and/or in the drying chamber. The products enter the oven 1 at its inlet 10 and are first of all dried in chamber 34. The food product is cooked in chamber 35 and then leaves the oven 1 via the outlet 12.

FIGS. 3 and 4 show an embodiment of the oven in the inventive line. The oven 1 comprises a first chamber 3 and a second chamber 4. The chambers 3, 4 are divided by means of a partition 2. In the present case, a rotatable drum 5, 6 is arranged in each of these chambers, around which the conveyor belt 7 is guided along two helical paths 8, 9. The endless conveyor belt enters the oven 1 via the entrance 10 here by a straight conveyor belt section 11 and leaves the oven 1 via the exit 12, here likewise by means of a straight section 13. The two helical sections are here connected by the straight conveyor belt section 14, which lies at the top. The belt is permeable to the process fluid, e.g. air and steam. The partition means 2 comprise a passage 2.1 for the belt section 14. This passage 2.1 is larger than the conveyor belt 14.

The heating means, which are overall denoted by 15, are arranged in the top of the housing. These heating means 15 each comprise a blower 16 here with a spiral casing 17, which opens into a duct 18. A heating element are situated in the ducts 18, respectively. The process fluid, e.g. air and steam, is sucked up by the blower 16 out of chambers 3, 4 via inlet 24 and is forced into the duct 18 via the spiral casing 17, respectively. The process fluid 31 flows past the heating elements 34 and is then recycled into the respective chamber 3, 4. Arrow 23, according to FIG. 3, depicts the fluid flow in the chamber 3, 4. The motion of the products (not depicted) to be cooked in the oven is depicted by arrows 29.

In a preferred embodiment, the drying and/or the smoking/flavoring takes place in the first chamber 3 and/or in the second chamber 4. In the second chamber 4, preferably the cooking and/or the smoking/flavoring takes place. Another preferred location, in which the smoking and/or the flavoring of the food product can be carried out is the chamber 36, in which the straight section of the conveyor belt is situated. The person skilled in the art understands that smoking/flavoring can take place in multiple locations in the oven.

According to another preferred or inventive concept, a smoking and/or drying substance is only ad- and/or absorbed by the food product after it has been dried to a certain extent. At least the surface of the food product has to be dried to a certain extent. After the food product enters the drying chamber 34 or the oven 1, it is dried. i.e. it starts losing weight. This weight loss can take place due to dropping of a liquid from the product and/or due to evaporation of a substance from the surface of the food product. It has now been found that only after the product has lost a certain amount of weight, the smoke and/or liquid is ab- and/or absorbed by the food product.

### REFERENCE SIGNS

1 oven
2 separation means, partition
2.1 passage from first- to second chamber
3 first chamber
4 second chamber
5 drum
6 drum
7 conveyor means, conveyor belt
8 helical section first chamber
9 helical section second chamber
10 inlet
11 straight conveyor means
12 outlet
13 straight conveyor means
14 connecting conveyor means section
15 heating means
16 blower
17 spiral casing
18 air duct
29 motion of the product
31 process fluid, air, steam and/or smoke
32 heating means
33 line
34 drying chamber
35 cooking chamber
36 smoking/flavoring chamber
37 connection conveyor

What is claimed is:

1. A line comprising:
an oven including:
at least one chamber,
a conveyor means that guides products from an inlet of the at least one chamber through the at least one chamber and to an outlet of the at least one chamber,
cooking means in the at least one chamber to cook the products
means to atomize a smoking- and/or a flavoring-liquid in the oven, wherein the smoking- and/or flavoring-liquid is atomized to a droplet size <3.0 μm, and a drying chamber upstream from the cooking means.

2. The line according to claim 1, wherein the drying chamber is a separate apparatus upstream from the oven.

3. The line according to claim 1, wherein the drying chamber is in the oven.

4. The line according to claim 3, wherein the drying chamber is in a first chamber of the oven with a helically shaped conveyor means.

5. The line according to claim 4, wherein the cooking means is in a second chamber of the oven with a helically shaped conveyor means.

6. The line according to claim 5, wherein the first and the second helical conveyor means of the first chamber and the second chamber are connected by straight conveyor means.

7. The line according to claim 6 wherein the means to provide a smoking- and/or a flavoring-substance into the oven are arranged a chamber with the straight conveyor means and/or in the first chamber.

8. The line according to claim 7, wherein each chamber has its own gas circulation.

9. The line according to claim 1, wherein the oven comprises temperature control means for adjusting and controlling the temperature and/or humidity in at least two chambers using a gas.

10. A process to dry and cook a food product comprising
cooking the food product
drying the food product upstream from the cooking of the food product;
smoking and/or flavoring the food product by means of a smoking- and/or flavoring-liquid; and
atomizing the smoking- and/or flavoring-liquid to a droplet size of <3.0 μm.

11. (canceled)

12. The process according to claim 10 wherein the food product is smoked- and/or flavored prior to the cooking or at least partially simultaneously during cooking.

13. The process according to claim 12, wherein the smoking- and/or a flavoring-takes place at least partially simultaneously to the drying step.

14. The process according to claim 12, wherein the smoking- and/or a flavoring-takes place after the drying step.

15. The process preferably according to claim 10, wherein the food product is dried to a certain extent before a smoking and/or flavoring substance is absorbed.

16. The process preferably according to claim 12, wherein the food product is dried to a certain extent before a smoking and/or flavoring substance is absorbed.

17. The process preferably according to claim 13, wherein the food product is dried to a certain extent before a smoking and/or flavoring substance is absorbed.

18. The process preferably according to claim 14, wherein the food product is dried to a certain extent before a smoking and/or flavoring substance is absorbed.

19. The line according to claim 7, wherein the oven comprises temperature control means for adjusting and controlling the temperature and/or humidity in at least two chambers using a gas.

20. The line according to claim 8, wherein the oven comprises temperature control means for adjusting and controlling the temperature and/or humidity in at least two chambers using a gas.
